(19) United States
(12) Patent Application Publication
(10) Pub. No.: US 2013/0271387 A1
(43) Pub. Date: Oct. 17, 2013

(54) WIRELESS COMMUNICATING ELECTRONIC DEVICE WITH TOUCH-SENSING KEY

(71) Applicants: JUN-XIN CHAI, Shenzhen City (CN); HSIN-NAN HU, Tu-Cheng (TW)

(72) Inventors: JUN-XIN CHAI, Shenzhen City (CN); HSIN-NAN HU, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/548,225

(22) Filed: Jul. 13, 2012

(30) Foreign Application Priority Data
Apr. 11, 2012 (CN) 201210104265.7

(51) Int. Cl. G06F 3/041

(52) U.S. Cl. 345/173

(57) ABSTRACT

A wireless communicating electronic device includes a wireless communication unit, a shell receiving the wireless communicating unit therein, a touch sensing unit, and a processing unit. The touch sensing unit includes an antenna, a regulating circuit, and an analog-digital (AD) converting module. A given portion spatially corresponding to the antenna defined on the shell. The antenna generates an alternating current (AC) signal in response to a finger touch on the given portion. The regulating circuit regulates the AC signal. The AD converting module converts the AC signal into a digital signal. The processing unit executes an instruction in response to the digital signal.

### BACKGROUND

1. Technical Field

The present disclosure relates to electronic devices and, particularly, to a wireless communicating electronic device with touch-sensing key.

2. Description of the Related Art

One or more mechanical keys or touch keys are generally employed on an electronic device for users to operate the electronic device. However, the mechanical keys are proteiform that may result in an invalid operations, and the electronic device with touch keys has to mount additional specific elements which makes a higher cost and a more complex manufacture process.

### BRIEF DESCRIPTION OF THE DRAWING

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is schematic diagram of a wireless communicating electronic device in accordance with an exemplary embodiment.

FIG. 2 is a block diagram of the wireless communicating electronic device of FIG. 1 in accordance with an exemplary embodiment.

### DETAILED DESCRIPTION

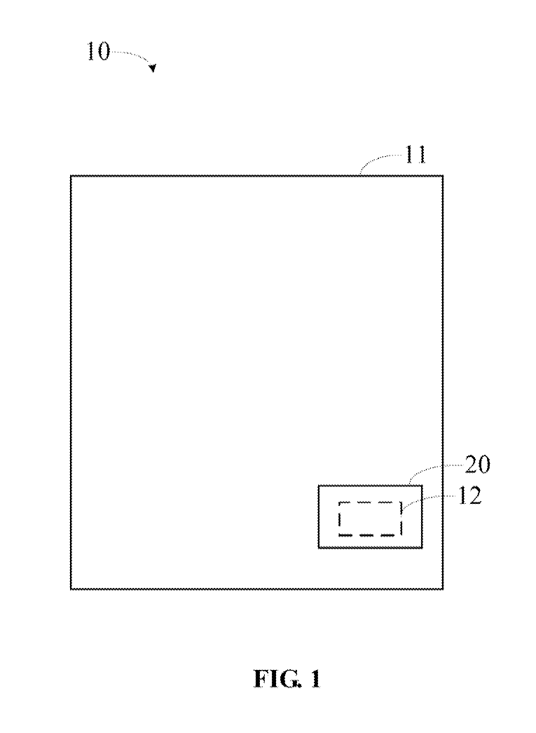

FIG. 1, illustrates a wireless communicating electronic device 10 of the embodiment. The electronic device 10 includes a shell 11 and a touch sensing unit 12. The electronic device 10 can be a mobile phone, or a tablet computer, for example.

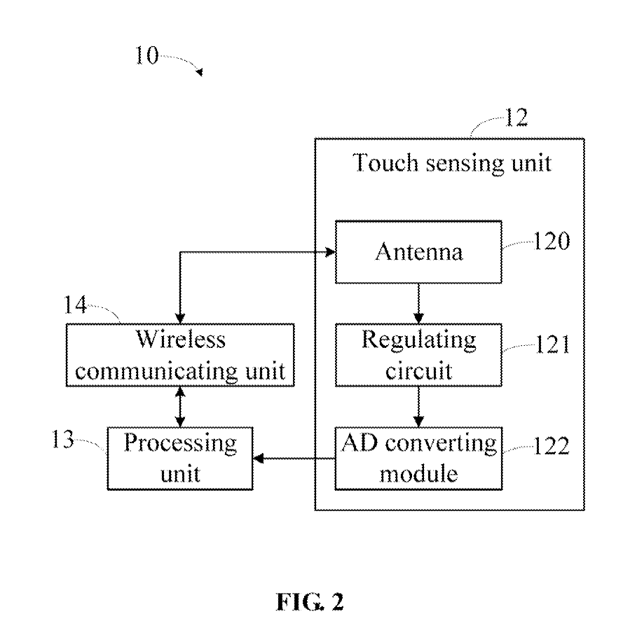

FIG. 2, illustrates further that the electronic device 10 includes a processing unit 13 and a wireless communicating unit 14. The shell 11 receives the wireless communicating unit 14 therein. The touch sensing unit 12 includes an antenna 120, a regulating circuit 121, and an analog-digital (AD) converting module 122. The shell 11 has a given portion spatially corresponding to the antenna 120. In the embodiment, the electronic device 10 includes a touch sensing key defined on the given portion. The wireless communicating unit 14 is connected between the antenna 120 and the processing unit 13. The wireless communicating unit 14 is configured for transmitting wireless signals of the electronic device 10 to others via the antenna 120 responding to the processing unit 13. In the embodiment, the wireless communicating unit 14 can be a 3G communicating module, an infrared communicating module, or a WiFi communicating module, for example.

The antenna 120 is also connected to the regulating circuit 121. The AD converting module 122 is connected between the regulating circuit 121 and the processing unit 13. The antenna 120 generates an alternating current (AC) signal in response to a finger touch on or near to the given portion. The regulating circuit 121 regulates the AC signal generated by the antenna 120. The AD converting module 122 converts the AC signal into a digital signal, and sends the digital signal to the processing unit 13. The processing unit 13 executes an instruction in response to the digital signal.

In the embodiment, the regulating circuit 121 regulates the value of the AC signal by filtering out high frequency signals and reserving the remaining. In other words, the high frequency signals are abandoned, which prevents the AD converting module 122 from breaking down from a larger AC signal generated by the antenna 120.

In an alternative embodiment, the electronic device 10 further includes a number of touch sensing units 12, and each touch sensing unit 12 is mounted in the shell 11 corresponding to a given portion spatially defined on the shell 11.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A wireless communicating electronic device, comprising:
a wireless communicating unit;
a shell receiving the wireless communicating unit therein;
a touch sensing unit comprising:
an antenna connected to the wireless communicating unit and configured for transmitting a wireless signal generated by the wireless communicating unit, the shell having a given portion spatially corresponding to the antenna, the antenna further configured for generating an alternating current (AC) signal in response to a finger touch on the given portion;
a regulating circuit configured for regulating the AC signal; and
an analog-digital (AD) converting module configured for converting the AC signal into a digital signal;
a processing unit configured for executing an instruction in response to the digital signal.

2. The wireless communicating electronic device as claimed in claim 1, wherein the wireless communicating unit is a 3G communicating module.

3. The wireless communicating electronic device as claimed in claim 1, wherein the regulating circuit is configured to regulate the value of the AC signal by filtering out high frequency signals of the AC signal and reserving the remaining.
